(19) United States
(12) Patent Application Publication
(10) Pub. No.: US 2015/0086002 A1
(43) Pub. Date: Mar. 26, 2015

(54) SYSTEM AND METHOD FOR MANAGING OUTBOUND INTERACTIONS

(71) Applicant: DRISHTI-SOFT SOLUTIONS PVT, LTD., Gurgaon (IN)

(72) Inventors: Nayan JAIN, Ghaziabad (IN); Prince Singh, Gurgaon (IN)

(73) Assignee: DRISHTI-SOFT SOLUTIONS PVT, LTD., Gurgaon (IN)

(21) Appl. No.: 14/037,285

(22) Filed: Sep. 25, 2013

(51) Int. Cl. H04M 3/523; H04M 3/51

(52) U.S. Cl. CPC H04M 3/5235; H04M 3/5158
USPC 379/265.1

(57) ABSTRACT

A method and system for managing a plurality of outbound interactions is provided. The system comprises an interaction management platform and a parallel predictive dialer. The parallel predictive dialer comprises multiple predictive dialers. The interaction management platform classifies multiple contacts into contact groups based on contact classification criteria and classifies multiple agents into agent groups based on agent classification criteria. Further, the interaction management platform, maps each the contacts in the contact groups to one or more the agent groups. The parallel predictive dialer assigns the predictive dialers to the agent groups and the predictive dialers place the outbound interactions to the contacts in the contact groups. The interaction management platform then determines available contacts from the contact groups and concurrently processes the answered interactions.

### FIELD OF INVENTION

The method and system disclosed herein, in general, relates to telephony and communications. More particularly, the method and system disclosed herein relates to managing a plurality of outbound interactions.

### BACKGROUND OF THE INVENTION

Customer targeting or solicitation is an integral part of promotional campaigns used by various business enterprises to increase their customer base. Traditionally, products and/or services were promoted using general advertising. As used herein, the term “general advertising” refers to a method of advertising where a business entity typically informs the public at large regarding its products and/or services without specifically targeting a particular customer group. However, general advertising is typically expensive and also not very efficient. Therefore, there is a need for promoting a product and/or service by direct selling, where the potential buyers or customers are approached personally by the business entity which wishes to promote its products and/or services.

Quite frequently, call centers assist business entities in the promotion of their products and/or services using the method of direct selling. Conventional methods of direct selling require call center agents to handle each call personally to gauge a customer's interest in the products and/or services that are being promoted. This then means that the call centers eventually spend precious time and resources on pursuing a single customer. It is therefore a time-consuming process and only marginal success is achieved in the conversion of potential customers into actual customers. This adversely affects the process of customer acquisition for the business entity. Therefore, in order to increase the probability of customer acquisition, the call centers automate the process of placing calls to the customers. For this purpose, the call centers employ automated dialers. An automated dialer refers to an electronic dialing device or software which automatically places outbound calls for the telephone numbers that are fed into the dialing system and proceeds on dialing on a continuous basis until the call is answered by a potential customer. Once the outbound call has been responded to by a potential customer, the call is transferred lo a call center agent who is responsible to handle the call.

Some automated dialers forecast the availability of a call center agent to handle a potential customer's call. These automated dialers are referred to as predictive dialers. Typically, the predictive dialers place interactions, such as calls to contacts in a campaign based on various parameters such as a predicted count of available agents, number of available contacts, time required to connect each contact, etc. When the contact answers the call, the call is transferred to. a free agent, in this method, the selection of the agent by the predictive dialers is done independent of selection of the contact that was called. Furthermore, these predictive dialers do not categorize the contacts and the agents into different groups, and as a result, are often rendered useless, especially when the skills of an agent do not match the requirements of a contact.

Moreover, the conventional predictive dialers perform predictions by considering all the call center agents as similar. Therefore, while the predictive dialers specify the number of call center agents who are available to take a particular call, they do not specify which of the call center agents would be available to handle the call. In numerous instances this leads to a scenario where the forecasted call center agents do not have the relevant and required expertise to handle a potential customer's call.

Prevailing automated dialers also do not provide for the facility to transfer customer responded interactions to a call center agent that are appropriately matched to a particular customer. This may result in the loss of opportunity to convert a potential customer into an actual customer and eventually leads to low rates of customer acquisition.

Hence, there exists a need for a method and system for managing multiple outbound interactions and matching each customer to an appropriate agent, thereby increasing talk times and productivity of the agents.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated need for managing a plurality of outbound interactions between multiple contacts and agents. An interaction management platform and a parallel predictive dialer are provided. The parallel predictive dialer comprises multiple predictive dialers.

The interaction management platform comprises a classification module, a mapping module, an availability determination module, and an interaction processing module. The classification module classifies a plurality of contacts into contact groups based on contact classification criteria. The contact classification criteria comprise, for example, geographical location, language, age, sex, interests, etc., of the contacts in the contact group. In an embodiment the classification module classifies the contacts into the contact groups by applying one or more logical rules to one or more, attributes of the contacts. The logical rules are referred to as “contact filters”.

In an embodiment, the interaction management platform further comprises a data acquisition module that acquires personal information of the contacts from various sources. The personal information comprise for example, name, phone number, address, age, etc., of a contact. The contact information of each of the contact in the contact groups is stored in a data repository in the interaction management platform.

Further, the classification module classifies the agents into agent groups based on agent classification criteria. The agent classification criteria comprise, for example, geographical location, language, skill sets, etc., of the agents in the agent groups. In an embodiment, the classification module classifies one or more of the agents under two or more agent groups.

The mapping module maps each of the contacts in the contact groups to one or more of the agent groups.

The parallel predictive dialer assigns the predictive dialers to the classified agent groups. The predictive dialers then place the outbound interactions to the contacts in the contact groups. In an embodiment, the predictive dialers parallelly predict number of contacts in each of the contact groups for placing the outbound interactions and availability of the agents prior to placing the outbound interactions to the contacts based on prediction criteria.

The availability determination module determines available contacts from the contact groups. As used herein, the term “available contacts” are the contacts who have answered the outbound interactions placed by the predictive dialers.

The interaction processing module concurrently processes answered interactions. As used herein, the term “answered interactions” refer to the outbound interactions that are answered by the available contacts. The interaction processing module assigns each of the available contacts to one of the agents from the agent groups and transfers each of the answered interactions to the assigned agent. That is, when a parallel predictive dialer dials out an outbound call to a contact and the call is answered, then the interaction processing module selects an agent from an agent group which is mapped to the contact, to converse with the contact.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 exemplarily illustrates a system for managing a plurality of outbound interactions.

FIG. 2 illustrates a method for managing a plurality of outbound interactions.

FIG. 3 exemplarily illustrates the architecture of a computer system employed by the interaction management, platform for managing the outbound interactions.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilised and that logical, mechanical, electrical and other changes may be made without departing from the scope of the embodiments. The following detailed description is, therefore, not to be taken in a limiting sense.

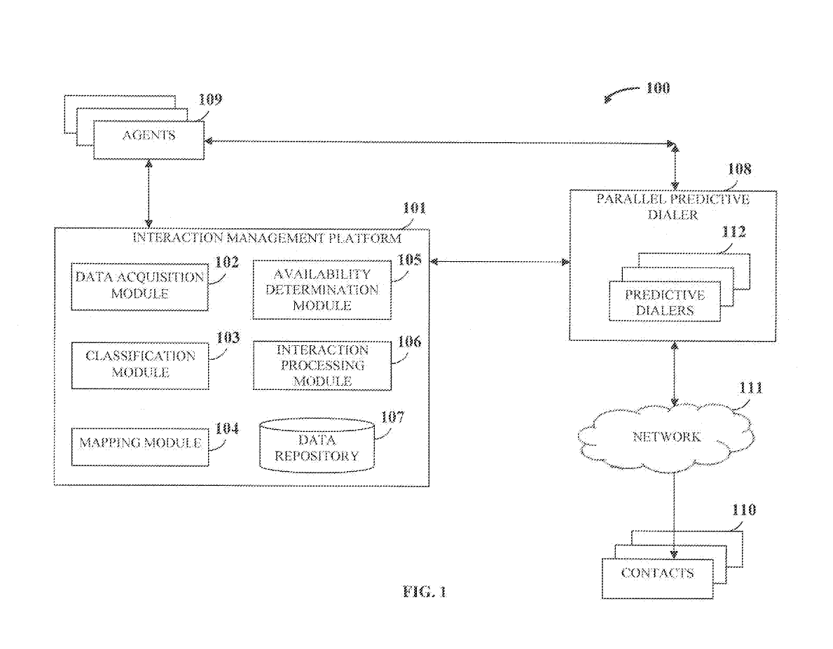

FIG. 1 exemplarily illustrates a system 100 for managing a plurality of outbound interactions. The system 100 comprises an interaction management platform 101 in communication with a parallel predictive dialer 108. The parallel predictive dialer 108 comprises a plurality of predictive dialers 112. As used herein, the term “outbound interactions” refers to an interactions initiated by the predictive dialers 112 to a customer on behalf of a client or a business entity. As used herein, the term “predictive dialers 112” refers to multiple devices that can automatically initiate multiple interactions simultaneously. The predictive dialers 112 are used for simultaneously placing the outbound interactions to multiple contacts 110. As used herein, the term “contacts 110” refers, to potential customers of a business enterprise, to who the business enterprise wishes to target promotional material or campaigns through agents 109 in a call center.

For the purposes of illustration, the “interactions” referred to in the detailed description refers to telephone calls; however, the scope of the “interactions” disclosed herein is not limited to telephone calls but may be extended to various other interactions, for example, online chat, video chat, email, short message service (SMS), web pushes, web collaborations, instant messaging, Multimedia Messaging Service (MMS), etc.

The predictive dialers 112 connect the agents 109 with the contacts 110 through a network 111. The network 111 is a telephone network and/or a data network that connects exchanges, switches, etc. The network 111 is, for example, a wired telephony network, a wireless network, a voice call network, a signaling system number 7 (SS7) network, an internet protocol data network, other data networks, etc.

The interaction management platform 101 comprises a classification module 103, a mapping module 104, an availability determination module 105, an interaction processing, module 106, and a data repository 107. The classification module 103 classifies a plurality of contacts 110 into contact groups based on contact classification criteria. The contact classification criteria comprise, for example, geographical location, language, age, sex, interests, etc., of a contact.

In an embodiment, the interaction management platform 101 further comprises a data acquisition module 102 that acquires personal information of the contacts 110 from various sources. The sources comprise, for example, lead generation campaigns, websites comprising interests of the contacts, surveys, institutes such as colleges, training institutes, etc. The data acquisition module 102 may also receive the personal information of the contacts via manual entry by an operator. The personal information comprises, for example, name, phone number, address, age, etc., of a contact. The contact information of each of the contact in the contact groups is stored in the data repository 107 of the interaction management platform 101. In an example, the classification module 103 classifies the contacts based on the geographical region of the contacts 110. In this example, the geographical location of each contact is identified and stored in the data repository 107. The classification module 103 classifies the contacts 110 into four groups—north contacts, east contacts, west contacts, and south contacts, based on the geographical region of the contacts 110.

Further, the classification module 103 classifies multiple agents 109 into agent groups based on agent classification criteria. The agent classification criteria comprise, for example, geographical location, language, skill sets, etc., of an agent. Each of the agent groups comprises at least one agent. In an example, the agents 109 are grouped based on the geographical location of the agents 109, for example, as north agents, east agents, west agents, and south agents.

In an embodiment, the classification module 103 classifies the contacts into the contact groups by applying one or more logical rules to one or more attributes of the contacts. The logical rules are referred to as “contact filters”. The attributes of the contacts are, for example, age, gender, interests, geographical location, etc. The classification module 103 applies the logical rules comprising, for example, AND, OR, NOT, LIKE, EQUAL, etc., on the attributes of a contact for creating the contact groups. In an example, a contact group comprises the following contacts: males OR females AND aged>21 AND interested in cars. The contacts 110 for who a particular logical rule or filter rule evaluates to “true”, together belong under one contact group.

The mapping module 104 maps each of the contacts 110 in the contact groups with one or more of the agent groups. That is, each contact is assigned to an appropriate agent group. Any of the agents 109 in the agent group associated with the contact may be assigned to converse with the contact. Consider an example, where the agents 109 and the contacts 110 are classified into multiple agent groups and contact groups respectively on the basis of the language spoken. In this example, the contacts 110 who speak Hindi are mapped to agent group/s which comprises agents 109 who can converse in Hindi.

The parallel predictive dialer 108 assigns the predictive dialers 112 to the agent groups. The predictive dialers 112 place the outbound interactions to the contacts in the contact groups. The predictive dialers 112 function independent of each other. In an embodiment the predictive dialers 112 concurrently place the outbound interactions to the contacts.

In an example, the outbound interactions are in the form of online messages, such as, online chat. In this embodiment, the predictive dialers 112 send chat messages to online contacts.

The availability determination, module 105 determines available contacts 110 from the contact groups. As used herein, the term “available contacts 110” are the contacts 110 who answer the outbound interactions placed by the predictive dialers 112.

In an embodiment, the predictive dialers 112 parallelly predict number of contacts 110 in each of the contact groups for placing the outbound interactions and availability of the agents 109 prior to placing the outbound interactions to the contacts based on prediction criteria. In this embodiment, the predictive dialers 112 first determine available agents in each of the agent groups. The predictive dialers 112 then select the contacts for placing the outbound interactions based on which of the agents are available. The prediction criteria comprise, for example, prior interaction patterns of the contacts 110 in the contact group, schedule of the agents 109, etc. For example, if a contact A from contact group XYZ is mapped to agent group BCD and all the agents 109 in the agent group BCD are busy, then the predictive dialers 112 will refrain from placing any outbound interactions to contact A, until one of the agents 109 from agent group BCD is predicted to be free. Therefore, the predictive dialers 112 minimize the time that the agents 109 spend waiting between interactions and minimize the occurrence of a contact 110 answering when no agent 109 is available. The interaction management platform 101 thereby determines which agents 109 are free rather than just how many agents 109 are free and matches the contacts to an appropriate agent.

Consider an example where during a regional festival, a relatively high number of contacts 110 of one region have put their phones on voicemail. In this example, the predictive dialers assigned to the particular region detect that a considerably high number of the placed outbound interactions are going to the voicemails of the contacts 110. The predictive dialers then increase the number of call attempts made to the contacts 110 of the region in order to keep the agents 109 sufficiently busy, thereby ensuring that talk time of the agents 109 remain sufficient enough to ensure acceptable productivity.

The parallel predictive dialer 108 thereby allows running of multiple predictive dialers 112 that performs the prediction and selection of the contacts 110 to be dialed on the basis of various attributes of the contacts 110 and how the agents 109 are mapped for catering to those attributes. In an example, the attribute for each contact is “region”.

The interaction processing module 106 concurrently processes answered interactions. As used herein, the term “answered interactions” refers to the outbound interactions that are answered by the available contacts 110. Further, the interaction processing module 306 assigns each of the available contacts 110 to one of the agents 109 from the agent groups and transfers each of the answered interactions to the assigned agent. That is, when predictive dialer 112 dials an outbound interaction to a contact and the interaction is answered by the contact, then the interaction processing module 106 selects a free agent from the agent group to which the contact is mapped. As used herein, the term “free agent” refers to an agent who is currently available to handle the answered interactions. For assigning an agent to a contact, the call processing may employ various assignment methods, for example, least recently used (LRU), etc. In the LRU method, when a call is answered by a contact, the interaction processing module 106 assigns the agent from an agent queue mapped to the contact who is least recently used.

In an embodiment, the classification module 103 classifies one or more of the agents under two or more agent groups. The agents 109 classified under two or more agent groups are herein referred to as “shared resource”. In this embodiment, the same agent may be assigned to contacts 110 belonging to different contact groups. Further, during assignment of the interactions to the agent, the interaction processing module 106 may consider the agent as available in equal fractions of time in each of the agent groups that the agent belongs to, or may consider the agent to be available in each agent group in a time slice or a weighted time slice manner, etc. The process of utilizing a shared resource to efficiently manage the outbound interactions is referred to as “resource blending”.

The interaction processing module 106 performs scheduling of the shared resource based on scheduling algorithms, for example, round robin scheduling, weighted scheduling, etc. In round robin scheduling, the interaction processing module 106 assigns free agents 109 to contacts 110 in a circular order, without priority. In weighted scheduling, the interaction processing module 106 assigns the tree agents 109 to the contacts 110 based on weights assigned for a shared resource to each contact group. In an example, a shared resource may be assigned weights of 30% of the agents' time in contact group X and 70% of the agent's time in contact group Y.

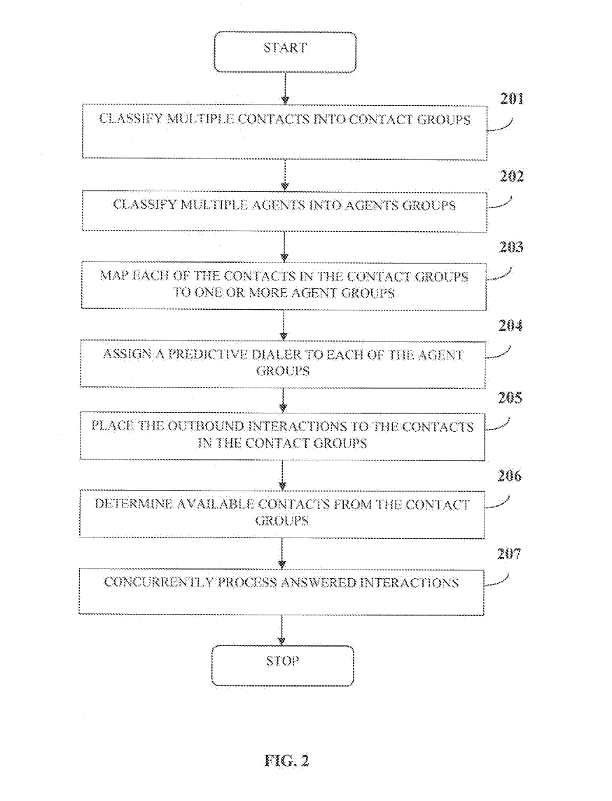

FIG. 2 illustrates a method for managing outbound interactions between multiple agents 109 and multiple contacts 110. The method comprises the steps of classifying a plurality of contacts 110 into contact groups based on contact classification criteria at step 201, classifying a plurality of agents 109 into agent groups based on agent classification criteria at step 202, mapping each the contacts 110 in the contact groups with one or more of the agent groups at step 203, assigning one of the predictive dialers to each of the agent groups at step 204, simultaneously placing the outbound interactions to the contacts 110 in the contact groups at step 205, determining available contacts 110 from the contact groups at step 206, and concurrently processing the answered interactions at step 207. In an embodiment, the predictive dialers 112 assigned to each of the agent groups parallelly predict number of the contacts in the contact groups and availability of the agents prior to placing the outbound interactions to the contacts based on prediction criteria.

In an embodiment, the Interaction management platform 101 disclosed herein runs locally on a computer system. In another embodiment, the interaction management platform 101 runs remotely over the network 111 by employing a web browser and a remote server, a mobile device, or other electronic devices.

Consider an example, where a telemarketing campaign has to reach out to 50000 contacts 110 across India. In this example, there are 20 agents 109 trained for the telemarketing campaign. Since the contacts 110 typically speak languages according to their geographical location, the interaction management platform 101 classifies the 50000 contacts 110 into 4 contact groups—north contacts, east contacts, east contacts, and west contacts. Further, the interaction management platform 101 classifies the agents 109 based on the language spoken by the agents 109 into four agent groups—north agent, south agent, east agent, and west agent.

The interaction management platform 101 then maps each contact in the contact groups to an agent group. In this example, each of the contacts 110 in the north contacts group are mapped to the north agent, each of the contacts 110 in the south contacts group are mapped to the south agent, each of the contacts 110 in the east contacts group are mapped to the east agent, and each of the contacts 110 in the west contacts group are mapped to the west agent.

In this example, four predictive dialers 112 are assigned to each of the four contact groups. The predictive dialers 112 then place the outbound interactions to the contacts 110 in the contact groups. The interaction management platform 101 then determines the available contacts from the contact groups. Further, the call processing platform assigns each of the available contacts 110 to a free agent based on a scheduling method and transfers the call to the assigned agent.

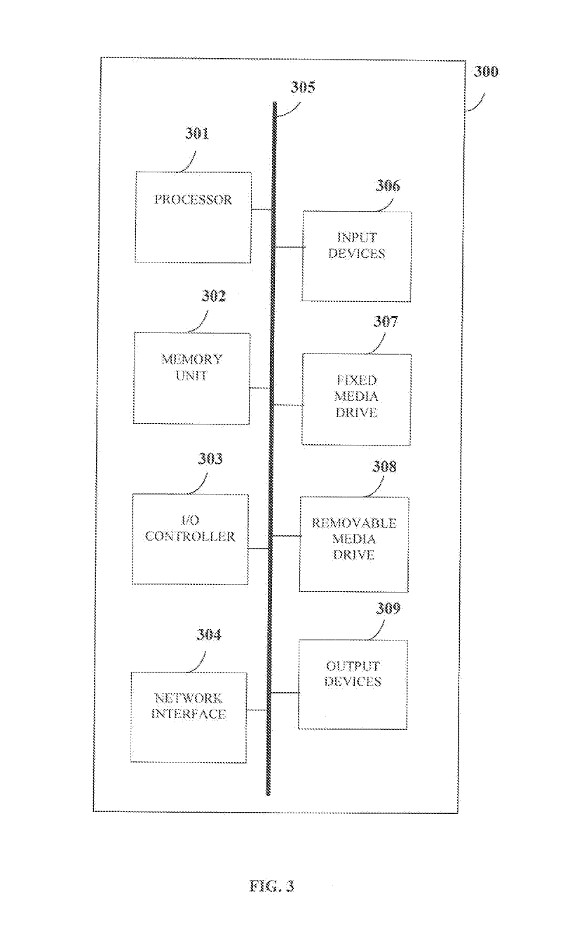

FIG. 3 exemplarily illustrates the architecture of a computer system 300 employed by the interaction management platform 101 managing a plurality of outbound interactions. The computer system 300 comprises, for example, a processor 301, a memory unit 302 for storing programs and data, an input/output (I/O) controller 303, a network interface 304, a data bus 305, input devices 306, output devices 309, etc.

The processor 301 is an electronic circuit that executes computer programs. The memory unit 302 stores programs, applications, and data. For example, the modules 101, 102, 103, 104, 105, 106, and 107 of the interaction management platform 101 are stored on the memory unit 302 of the computer-system 300. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 may further comprise a read only memory (ROM) or another type of static storage device that stores static information and instructions for the processor 301. The network interface 304 enables connection of the computer system 300 to the network. The network interface 304 comprises, for example, an infrared (IR) interface, a WiFi interface, a universal serial bus interface (USB), a local area network (LAN), a wide area network (WAN) interface, etc. The I/O controller 303 controls the input and output actions performed, for example, by administrators of the interaction management platform 101. The data bus 305 permits communication between the modules, for example, 101, 102, 103, 104, 103, 106, 107, etc., of the interaction management platform 101.

The input devices 306 are used for inputting data into the computer system 300. The input devices 306 are, for example, a keyboard such as an alphanumeric keyboard, a joystick, a mouse, a touch pad, a light pen, etc. The output devices 309 output the results of the actions computed by the interaction management platform 101, for example, to administrators of the interaction management platform 101.

The computer system 300 may comprise, for example, a fixed media drive 307 and a removable media drive 308 for receiving removable media. Computer applications and programs are used for operating the computer system 300. The programs may be loaded onto the fixed media drive 307 and into the memory unit 302 of the computer system 300 via the removable media drive 308. In an embodiment, the computer applications and programs may be loaded directly via a communication network.

The processor 301 retrieves the instructions for executing the modules, for example, 101, 102, 103, 104, 105, 106, 107, etc., of the interaction management platform 101 from the program memory in the form of signals. A program counter determines the location of the instructions in the program memory. The program counter stores a number that identifies the current position in the program of the modules, for example, 101, 102, 103, 104, 105, 106, 107, etc., of the interaction management platform 101.

The instructions fetched by the processor 301 from the program memory after being processed are decoded. The instructions are placed in an instruction register in the processor 301. After processing and decoding, the processor 301 executes the instructions. For example, the classification module 103 defines instructions for classifying a plurality of contacts into contact groups and a plurality of agents into the agent groups. The mapping module 104 defines instructions for mapping each of the contacts in the contact groups to one or more of the agent groups. The availability determination module defines instructions for determining available contacts from the contact groups. The call processing module defines instructions for concurrently processing answered interactions.

The processor 301 of the interaction management platform 101 retrieves the instructions defined by the data acquisition module 102, the classification module 103, the mapping module 104, the availability determination module 105, the interaction processing module 106, and the data repository 107 and executes the instructions to obtain one or more outputs.

For purposes of illustration, the detailed description refers to the interaction management platform 101 being run locally on a computer system 300; however the scope of the computer implemented method and system 100 disclosed herein is not limited to the interaction management platform 101 being run locally on the computer system 300 via the processor 301, but may be extended to run remotely over a communication network by employing a web browser and a remote server, a mobile device, or other electronic devices.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method for managing a plurality of outbound interactions, comprising:
providing an interaction management platform in communication with a parallel predictive dialer, wherein the parallel predictive dialer comprises a plurality of predictive dialers;
classifying a plurality of contacts into contact groups based on contact classification criteria by the interaction management platform;
classifying a plurality of agents into agent groups based on agent classification criteria by the interaction management platform;
mapping each of the contacts in the contact groups to one or more of the agent groups by the interaction management platform;
assigning the predictive dialers to the classified agent groups by the parallel predictive dialer and placing the outbound interactions by each of the predictive dialers to the contacts in the contact groups;
determining available contacts from the contact groups by the interaction management platform, wherein the available contacts comprise the contacts who have answered the outbound interactions; and
concurrently processing answered interactions by the interaction management platform, wherein the answered interactions comprise the outbound interactions that are answered by the available contacts, and wherein the processing of the answered interactions comprises:
assigning each of the available contacts to one of the agents from the agent groups; and
transferring each of the answered interactions to the assigned agent.

2. The method of claim 1, further comprising acquiring personal information of each of the contacts in the contact groups from a plurality of sources by the interaction management platform.

3. The method of claim 1, wherein the contact classification criteria comprise one or more of geographical location, language, age, sex, and interests of the contacts in the contact groups.

4. The method of claim 1, wherein the agent classification criteria comprise geographical location, language, and skill sets of the agents in the agent groups.

5. The method of claim 1, further comprising parallelly predicting number of contacts in each of the contact groups for placing the outbound interactions and availability of the agents prior to placing the outbound interactions to the contacts based on prediction criteria by the predictive dialers.

6. The method of claim 1, wherein the interaction management platform classifies the contacts into the contact groups by applying one or more logical rules to one or more attributes of the contacts.

7. The method of claim 1, further comprising classifying one or more of the agents under two or more agent groups.

8. A system for managing a plurality of outbound interactions, comprising:
a parallel predictive dialer comprising a plurality of predictive dialers, wherein the predictive dialers are assigned to the agent groups for placing the outbound interactions to a plurality of contacts; and
an interaction management platform comprising:
a classification module that classifies a plurality of contacts into contact groups based on contact classification criteria and classifies a plurality of agents into the agent groups based on agent classification criteria;
a mapping module that maps each of the contacts in the contact groups to one or more of the agent groups;
an availability determination module that determines available contacts from the contact groups, wherein the available contacts comprise the contacts who have answered the outbound interactions; and
an interaction processing module that concurrently processes answered interactions, wherein the answered interactions comprise the outbound interactions that are answered by the available contacts.

9. The system of claim 8, wherein the interaction management platform further comprises a data acquisition module that acquires personal information of each of the contacts in the contact groups from a plurality of sources.

10. The system of claim 8, wherein the predictive dialers assigned to the agent groups parallelly predict number of contacts in each of the contact groups for placing the outbound interactions and availability of the agents prior to placing the outbound interactions to the contacts, based on prediction criteria.

11. The system of claim 8, wherein the classification module classifies the contacts into the contact groups by applying one or more logical rules to one or more attributes of the contacts.

12. The system of claim 8, wherein the classification module classifies one or more of the agents into two or more agent groups.
